(19) United States
(12) Patent Application Publication
(10) Pub. No.: US 2005/0180088 A1
(43) Pub. Date: Aug. 18, 2005

(54) Substrate attaching device and method

(75) Inventors: Ching-Wei Chiang, Miao-Li (TW); Yen-Chung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/026,075

(22) Filed: Dec. 30, 2004

(30) Foreign Application Priority Data
Feb. 14, 2004 (CN) 2004100153855

(51) Int. Cl. H01H 1/00

(52) U.S. Cl. 361/234

(57) ABSTRACT

A substrate attaching device (100) includes a first electrostatic chuck (30), a second electrostatic chuck (40) set below the first electrostatic chuck, and a controller (45). The controller alternately changes the polarity of a voltage applied on the second electrostatic chuck so as to eliminate static electricity on attached substrates (36, 46). Operation of the substrate attaching device does not carry micro-particles to the substrates. A method for attaching two substrates together using the substrate attaching device comprises: holding a first one of the substrates and a second one of the substrates to the first electrostatic chuck and the second electrostatic chuck, respectively; moving the first electrostatic chuck and the second electrostatic chuck closer together until the first substrate and the second substrate are attached together; and changing the polarity of a voltage applied on one of the first electrostatic chuck and the second electrostatic chuck alternately.

### BACKGROUND OF THE INVENTION

1. Field of the Invention

The present invention relates to a substrate attaching device and a substrate attaching method, and especially to a device used for combining two substrates such as those that form the framework of a liquid crystal display (LCD) cell.

2. Description of Prior Art

A main step in the production of an LCD cell is to attach two substrates together in a vacuum chamber. The substrates are joined by a peripheral line of sealant sandwiched therebetween, which together cooperatively form a space therebetween for retaining liquid crystal molecules therein.

One of the substrates already has a circuit formed thereon prior to attachment to the other substrate. In the attachment process, any static electricity produced by the substrates or the attaching device must be eliminated. If the static electricity is not timely eliminated, the accumulated static electricity can damage the circuit on the substrate.

Referring to FIG. 6, this shows a conventional substrate attaching device having the function of eliminating static electricity. The substrate attaching device comprises a first electrostatic chuck (ESC) 10, a second ESC 20, and two ionizers 13, 23.

The first ESC 10 comprises a first chuck body 11, a first electrode 12 embedded in the first chuck body 11, and a first power supply 14 connecting to the first electrode 12. The second ESC 20 is set below the first ESC 10, and comprises a second chuck body 21, a second electrode 22 embedded in the second chuck body 21, and a second power supply 24 connecting to the second electrode 22. The first power supply 14 and second power supply 24 provide direct current with high voltage. Each of the first power supply 14 and the second power supply 24 has a grounded end.

When the first power supply 14 and second power supply 24 apply voltage on the first electrode 12 and the second electrode 22, respectively, the first electrode 12 and the second electrode 22 are respectively charged. The accumulated charge produces electrostatic attraction, whereby the first ESC 10 attracts and holds a first substrate 15 and the second ESC 20 attracts and holds a second substrate 25.

After the two substrates 15, 25 are attached to the two ESCs 10, 20, respectively, the first ESC 10 is lowered, and the first substrate 15 is attached to the second substrate 25 on the second ESC 20. The ionizers 13, 23 are disposed close to the substrates 15, 25, respectively. The ionizers 13, 23 produce a mixture of positive ions and negative ions, and blow the mixture of positive ions and negative ions to the substrates 15, 25 to neutralize the static electricity of the substrates 15, 25. The continuous operation of the ionizers 13, 23 can avoid the accumulation of static electricity. Thus, the circuit on either of the substrates 15, 25 is protected.

However, the ionizers 13 and 23 operate as fans. The flowing mixture of positive ions and negative ions can also carry micro-particles to the substrates 15, 25. The micro-particles may scratch or damage the substrates 15, 25, which can result in impaired performance or failure of the LCD cell.

Thus, a new substrate attaching device and a new substrate attaching method which overcome the above-mentioned disadvantages are desired.

### SUMMARY OF THE INVENTION

An object of the present invention is to provide a substrate attaching device that can eliminate static electricity on the substrates such that no micro-particles are carried to the substrates.

Another object of the present invention is to provide a substrate attaching method that can eliminate static electricity on the substrates such that no micro-particles are carried to the substrates.

In order to achieve the first object set out above, a substrate attaching device comprises a first electrostatic chuck, and a second electrostatic chuck set below the first electrostatic chuck. The polarity of a voltage applied on one of the first electrostatic chuck and the second electrostatic chuck can be changed alternately. The changes of the polarity of the voltage can eliminate static electricity on the attached substrates.

In order to achieve the second object set out above, a method for reliably attaching two substrates together comprises: providing a substrate attaching device with a first electrostatic chuck and a second electrostatic chuck set below the first electrostatic chuck; holding a first one of the substrates and a second one of the substrates to the first electrostatic chuck and the second electrostatic chuck, respectively; moving the first electrostatic chuck and the second electrostatic chuck closer together until the first substrate and the second substrate are attached together; and changing the polarity of a voltage applied on one of the electrostatic chuck and the second electrostatic chuck alternately.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, side cross-sectional view of a first embodiment of a substrate attaching device according to the present invention;

FIGS. 2 to 4 are schematic, side cross-sectional views showing successive steps in a method for attaching two substrates together, the method being performed using the substrate attaching device of FIG. 1;

FIG. 5 is a schematic, side cross-sectional view of a second embodiment of a substrate attaching device according to the present invention, also showing two substrates attached by the substrate attaching device; and

FIG. 6 is a schematic, side cross-sectional view of a conventional substrate attaching device.

### DETAILED DESCRIPTION OF THE INVENTION

Reference will now be made to the drawings to describe the present invention in detail.

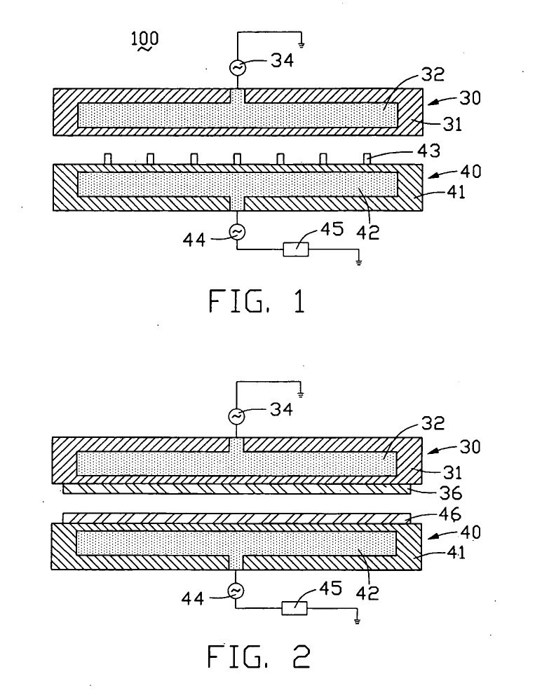

Referring to FIG. 1, a first embodiment of a substrate attaching device 100 in accordance with the present invention comprises a first ESC 30, a second ESC 40, and a controller 45.

The first ESC 30 comprises a first chuck body 31, a first electrode 32 embedded in the first chuck body 31, and a first power supply 34 connecting to the first electrode 32. The second ESC 40 is set below the first ESC 10, and comprises a second chuck body 41, a second electrode 42 embedded in the second chuck body 41, and a second power supply 44 connecting to the second electrode 42. The second chuck body 41 comprises a plurality of supporting pins 43 extending up from a top face thereof. The supporting pins 43 can retract into the second chuck body 41 and rebound back out from the second chuck body 41. For example, the supporting pins 43 may be spring-loaded. The controller 45 connects with the second power supply 44.

The first power supply 34 and the second power supply 44 apply a direct current with high voltage on the first ESC 30 and the second ESC 40, respectively. One end of the first power supply 34 connects to the first electrode 32, and the other end of the first power supply 34 is grounded. One end of the second power supply 44 connects to the second electrode 42, and the other end of the second power supply 44 is grounded. The controller 45 is connected between said other end of the second power supply 44 and the ground. The controller 45 can change the polarity of the voltage applied on the second ESC 40 alternately.

FIGS. 2 to 4 are schematic, cross-sectional views showing successive steps in a method for attaching two substrates together, the method being performed using the substrate attaching device 100. Details of the method are as follows:

Referring to FIG. 2, a first substrate 36 and a second substrate 46 are attached to the substrate attaching device 100 by electrostatic attraction. When a voltage is applied on the first electrode 32 by the first power supply 34, a charge is formed and accumulated on the first electrode 32. The first ESC 30 attracts the first substrate 36 by electrostatic attraction. When a voltage is applied on the second electrode 42 by the second power supply 44, a charge is formed and accumulated on the second electrode 42. The second ESC 40 attracts the second substrate 46 by electrostatic attraction. When the second substrate 46 is attracted by the second ESC 40, the second substrate 46 pushes the supporting pins 43 down into the second ESC 40, and the second substrate 46 contacts the top face of the second chuck body 41.

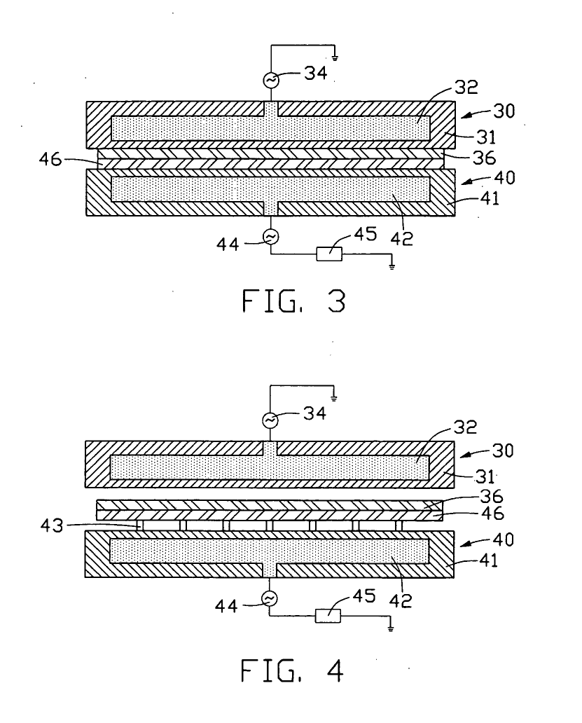

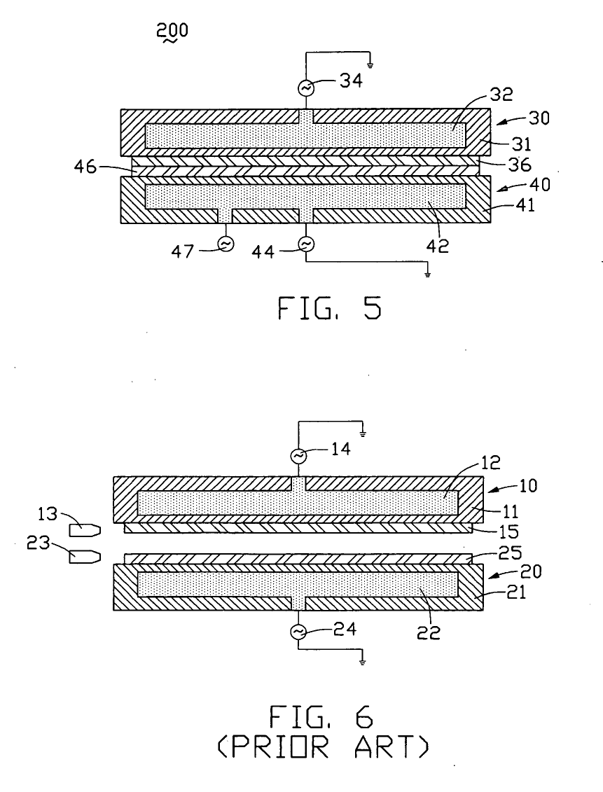

Referring to FIG. 3, the two substrates 36 and 46 are attached together by the substrate attaching device 100. After the substrates 36 and 46 are respectively attached to the two ESCs 30 and 40, the first ESC 30 moves down toward the second substrate 46 until the first substrate 36 is attached to the second substrate 46.

Referring to FIG. 4, this shows how static electricity formed on the substrates 36 and 46 by the substrate attaching device 100 is eliminated. After the substrates 36 and 46 are attached as FIG. 2, the first power supply 34 stops applying voltage to the first electrode 32, and the first substrate 36 is no longer attracted to the first electrode 32. Then, the first ESC 30 moves up to an appropriate height above the first substrate 36. However, there is still static electricity accumulated on the combined substrates 36 and 46. Before the combined substrates 36 and 46 are raised by the supporting pins 43, the controller 45 changes the polarity of the voltage applied on the second ESC 40 alternately. The alternate change of the polarity of the voltage can neutralize the static electricity on the substrates 36 and 46. Then, the second power supply 44 stops applying voltage on the second electrode 42, and the combined substrates 36 and 46 are raised by the supporting pins 43. The combined substrates 36 and 46 are then easily taken out from the substrate attaching device 100.

The substrate attaching device 100 utilizes the change of polarity of the voltage applied on the second ESC 40 to eliminate static electricity accumulated on the two substrates 36, 46. No ionizers are needed, and no micro-particles are carried to the substrates 36, 46 by the flowing ions. Therefore, the substrate attaching device 100 can prevent scraping or damage being caused to the substrates 36, 46 by particles, and thus improve yield.

Referring to FIG. 5, a second embodiment of a substrate attaching device 200 in accordance with the present invention has essentially the same structure as that of the substrate attaching device 100. In particular, the substrate attaching device 200 comprises a third power supply 47 which can apply an alternating current voltage on the second ESC 40. Before the combined substrates 36 and 46 are raised by the supporting pins 43, the power supply 47 apply an alternating current on the second ESC 40. Thus, static electricity accumulated on the two substrates 36, 46 can be eliminated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A substrate attaching device, comprising:
a first electrostatic chuck; and
a second electrostatic chuck set below the first electrostatic chuck;
wherein, the polarity of a voltage applied on one of the first electrostatic chuck and the second electrostatic chuck can be changed alternately.

2. The substrate attaching device as recited in claim 1, wherein the first electrostatic chuck comprises a first chuck body, a first electrode embedded in the first chuck body, and a first power supply connecting to the first electrode.

3. The substrate attaching device as recited in claim 2, wherein a voltage is applied on the first electrostatic chuck by the first power supply.

4. The substrate attaching device as recited in claim 1, wherein the second electrostatic chuck comprises a second chuck body, a second electrode embedded in the second chuck body, and a second power supply connecting to the second electrode.

5. The substrate attaching device as recited in claim 4, wherein a voltage is applied on the second electrostatic chuck by the second power supply.

6. The substrate attaching device as recited in claim 5, further comprising a controller, wherein the controller connects with the second electrostatic chuck and can change the polarity of the voltage applied on the second electrostatic chuck alternately.

7. The substrate attaching device as recited in claim 4, wherein the second chuck body comprises a plurality of supporting members, the supporting pins can raise or lower corresponding to the second chuck body.

8. The substrate attaching device as recited in claim 2, wherein the first power supply provides direct current with high voltage.

9. The substrate attaching device as recited in claim 4, wherein the second power supply provides direct current with high voltage.

10. The substrate attaching device as recited in claim 2, wherein the first power supply has a grounded end.

11. The substrate attaching device as recited in claim 6, wherein the second power supply has a grounded end, and the controller is connected between the second power supply and ground.

12. The substrate attaching device as recited in claim 5, further comprising a third power supply which provides alternating current on the second electrostatic chuck.

13. A method for reliably attaching two substrates together, comprising:
providing a substrate attaching device with a first electrostatic chuck and a second electrostatic chuck set below the first electrostatic chuck;
holding a first one of the substrates and a second one of the substrates to the first electrostatic chuck and the second electrostatic chuck, respectively;
moving the first electrostatic chuck and the second electrostatic chuck closer together until the first substrate and the second substrate are attached together; and
changing the polarity of a voltage applied on one of the first electrostatic chuck and the second electrostatic chuck alternately.

14. The method as recited in claim 13, wherein the substrates are held to the electrostatic chucks by electrostatic attraction.

15. The method as recited in claim 13, wherein a voltage is applied on the second electrostatic chuck by a power supply.

16. The method as recited in claim 15, wherein the polarity of the voltage applied on the second electrostatic chuck is changed by a controller connected between the power supply and ground.

17. A method for operation of a substrate, comprising steps of:
providing a substrate attaching device with an electrostatic chuck;
sucking the substrate via accumulation of electrostatics derived from said electrostatic chuck;
applying operation upon said held substrate; and
removing and counterbalancing the electrostatics remaining on the substrate by generating opposite electrostatics by said electrostatic chuck.
